(19) United States
(12) Patent Application Publication
(10) Pub. No.: US 2004/0065792 A1
(43) Pub. Date: Apr. 8, 2004

(54) Universal pan and tilt mounting system

(76) Inventors: Tom W. Yost, Huntsville, AL (US); Keith Foslien, Huntsville, AL (US)

Correspondence Address: Legal Office, (AMSAM-L-G-I, Mr. Fred M. Bush), US Army Aviation and Missile Command, Redstone Arsenal, AL, 35898-5000, US

(21) Appl. No.: 10/265,423

(22) Filed: Oct. 7, 2002

(51) Int. Cl. F16M 11/02

(52) U.S. Cl. 248/181.1

(57) ABSTRACT

A universal mounting system for a device that employs a directional element in the operation of that device (e.g., scanning, tracking, aiming, or firing) is disclosed. The system is designed to perform pan and tilt operations associated with an attached device in a single movement without the need for operator adjustments. The design allows for mounting the system via a specific method or a commonly utilized method. Additional components may include an elevation adjustment to the system and a friction adjustment to the means used for the pan and tilt operations.

### DEDICATORY CLAUSE

The invention described herein may be manufactured, used and licensed by or for the Government for governmental purposes without the payment to the inventors of any royalties thereon.

### BACKGROUND OF THE INVENTION

1. Field of the Invention

There currently exist several applications of a mounting system such that a device attached to that system may be tilted (or raised) up or down and panned right or left. Those devices for which mounting systems are typically designed include water (or other substances) cannons, weapon systems, telescopes and cameras.

The Javelin Weapon System is a medium range, manportable, shoulder-launched, fire and forget, anti-armor weapon system. The Javelin Weapon System has two major components: a reusable Command Launch Unit and a round assembly. The round assembly consists of a missile sealed in a disposable launch tube assembly. The Command Launch Unit can be used (with or without the round) for day or night battlefield surveillance. The Command Launch Unit when mated with a round, can launch the missile.

The Javelin Weapon System is designed to weigh less than 49.5 pounds. During use, the soldier may elect to operate the unit from a prone, sitting, or standing position. Almost invariably, the soldier elects to use the sitting position with crossed legs and elbows propped on the knees for support and stability. The use of the Javelin Weapon System over extended periods, such as during surveillance, can cause fatigue and impair the soldier's stability and accuracy.

While the idea for this universal mounting system originated with the needs of the Javelin Weapon System, the benefits of the universal mounting system are not limited to just the Javelin Weapon System. Any situation where a device is directed by panning and tilting would benefit from the universal mounting system. Other applications might include the directing of a liquid for firefighter, crowd control, or farming purposes. The background of the universal mounting system and prior art indicate that the most likely applications of the universal mounting system would be for national defense and civil defense purposes. When compared to prior art, the universal mounting system will improve accuracy and effectiveness, allow for more freedom of movement and improved control, and reduce the risk of injury and fatigue to human operators.

2. Description of Prior Art

a. In U.S. Pat. No. 5,871,186 issued Feb. 16, 1999, there is disclosed a support device consisting of a stand and a holder connected by a ball-and-socket joint. A means for fixing and locking the swivel motion of the holder about the ball-and-socket joint is disclosed. The prior art has a specifically designed holder which limits the range of applications. This prior art employs friction in its fixing and locking functions.

b. In U.S. Pat. No. 5,664,750 issued Sep. 9, 1997, there is disclosed a camera mount having a base clamp for mounting, an adaptor for angling a mast with respect to the base clamp, ball joints for angling additional masts, and the use of friction as a locking means for the ball joint. This prior art is designed to retain a fixed position with regard to the point at which the mount is attached to its environment.

c. In U.S. Pat. No. 5,922,987 issued Jul. 13, 1999, there is disclosed a weapon systems mount utilizing a hydraulic system with two separate mechanisms for “traverse and elevation” and a hydraulic valve for adjusting the freedom of movement. This patent discusses in detail the limitations of art prior to its own invention: “poor target acquisition time, operational complexity, backlash, and loose parts.” This prior art employs resistance in the hydraulic component to lock, unlock, and improve movement of the weapon system.

d. In U.S. Pat. No. 4,615,487 issued Oct. 7, 1986, there is disclosed a hydrocannon system with tilt, pan, and elevation capabilities. The components utilized by this prior art for the tilting and panning functions are performed by two independent components which have no controlled friction or locking capability. A means for elevating the hydrocannon system in a fixed position with respect to the base is provided.

In some fields noted above (See references a. and b.), a pan and tilt function is not the primary (or even an intended) objective of the prior art. In those fields the prior art is not well suited for an operator-controlled pan and tilt function. In other fields (See references c. and d.), the tilt and pan functions are performed by two or more independent or cooperating components. This plurality of components and operations maybe a disadvantage when speed is required during panning and tilting. A plurality of components also can increase the cost of manufacturing and the maintenance requirements. The prior art generally has been designed around a specific device and is not well suited for a multiplicity of devices requiring operator-controlled panning and titling functions.

Each individual component of the universal mounting system has been used for similar purposes in prior art with the exception of applying mechanical friction to the ball joint to increase operator control during panning and tilting. No prior art has been found which teaches that application of mechanical friction. Notwithstanding the obviousness of an individual component's use, the universal mounting system discloses a unique combination of functions and components which is not found in the prior art. Indeed, prior art in these fields appears to contain patents based on the combination of known functions and components in new and unique ways. The universal mounting system's unique combination in such well-developed fields, and for which there is a recognized commercial and public value, is a strong indication that such a combination is not obvious to those skilled in the art associated with these fields. Generally, the prior art has been designed for a specific purpose and, therefore, may be desirable for some devices. However, there are other devices, such as the Javelin Weapon System, and other uses (e.g., rapid and controlled scanning, tracking, aiming, or firing) for which the universal mounting system is a superior mounting system.

One objective of the universal mounting system is a pan and tilt function that provides increased operator control and speed for a device that employs a directional element in the operation of that device (e.g., scanning, tracking, aiming, or firing). The universal mounting system is designed to be readily adapted to individual operator needs (e.g., height, support of device weight, and stability), device requirements (e.g., mounting to various bases and attaching various devices), and operator preferences (e.g., degree of resistance during tilt and pan operation). The universal mounting system accomplishes all of these objectives by a unique combination of components which require no further action by the individual operating the attached device after initial set up, while allowing for ease of adjustments, if desired, during operation. In some applications, the universal mounting system will reduce operator fatigue and enhance operator safety.

### SUMMARY OF THE INVENTION

The universal mounting system has an upper and a lower rigid structure that are connected such that the upper rigid structure is allowed to tilt up or down and pan right or left with respect to the lower rigid structure. The upper rigid structure is designed for the ready attachment of a specific device or a type or class of devices. The lower rigid structure has a widely utilized component for attaching the lower rigid structure to a base. An elevation component maybe added such that the height of the device attached to the upper rigid structure may be adjusted with respect to the point at which the lower rigid structure is mounted to a base.

### DESCRIPTION OF THE DRAWING

FIG. 1 is a side view of the preferred embodiment of the universal mounting system.

FIG. 2 is an enlarged side view of the pintle connector.

FIG. 3 is an overhead view of a Javelin specific component set for attachment of the Javelin Weapon System.

FIG. 4 is the Javelin Weapon System in its two configurations.

FIG. 5 contains two side views of the preferred embodiment integrated with the Javelin Weapon System in its two configurations.

### DESCRIPTION OF THE PREFERRED EMBODIMENT

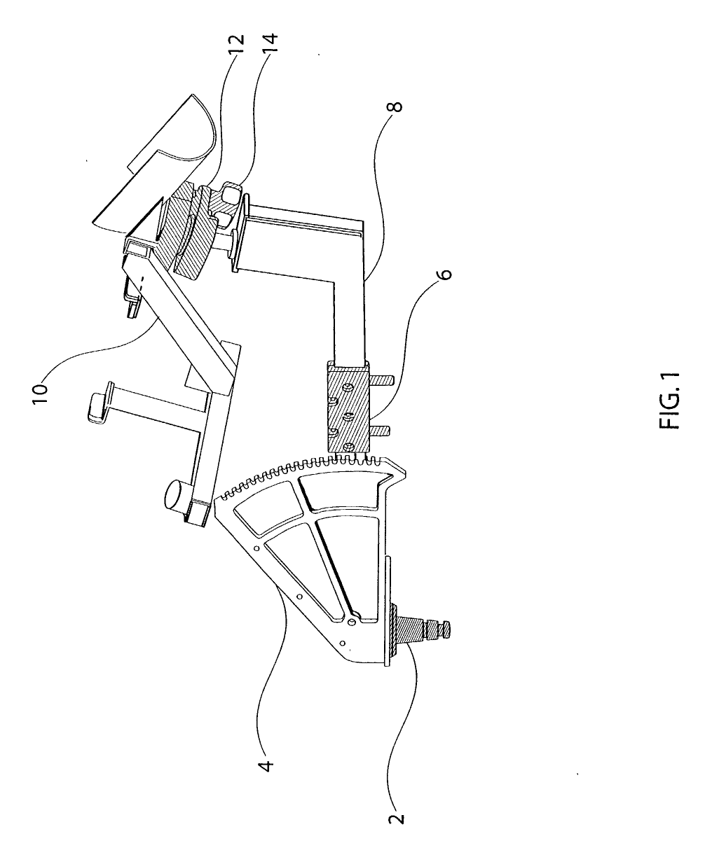

Referring now to the drawings wherein like numbers represent like parts, the preferred embodiment of a universal pan and tilt mounting system is illustrated in FIG. 1. A pintle type connector 2 for mounting the universal mounting system to a base is coupled with an optional elevation-gear pawl assembly 4 and 6. The optional assembly 4 and 6 is more fully described below. The elevation-gear pawl assembly 4 and 6 is rigidly attached to a lower rigid structure 8 extending away from the assembly 4 and 6. The lower rigid structure 8 and the pintle connector 2 may be directly coupled to each other if the elevation feature is not desired. The lower rigid structure 8 may be constructed in any form, such as straight or L-shaped, that accommodates the application of the system. In the preferred embodiment, the lower rigid structure 8 is roughly L-shaped for use of the system with the Javelin Weapon System attached and with the system mounted on a generally level base. The means for coupling, securing or attaching all components of this system are well known in the art and are not shown. The lower rigid structure 8 and a Javelin specific component set 10 are joined by a ball joint assembly 12. The ball joint assembly 12 has incorporated a friction means 14 for setting and maintaining a constant amount of friction to the ball joint 12. The preferred embodiment uses an adjustable control knob for the friction means. The degree of friction ranges from free movement to full lock. The means for applying friction to a ball joint is well known in the art and is not further described. The Javelin specific component set 10 supports and secures the Javelin Weapon System in either configuration: Command Launch Unit only or Command Launch Unit mated with a round.

In the preferred embodiment, the Javelin specific component set 10 combines two claimed elements into a single component. Those two elements are the upper rigid structure and the means for attaching a device. In other embodiments another device specific component set may be substituted for the Javelin specific component set 10. In some embodiments an upper rigid structure may be designed such that it is joined by the ball joint assembly 12 to the lower rigid structure 8 and has at least one common connecting means. Such common connecting means would include, without limitation, pins, bolts, clamps, and pintels. The component that performs the means for attaching a device function would then be connected to the upper rigid structure utilizing the common connector. The use of a common connector means would allow multiple devices to be rapidly and easily attached to and removed from the mounting system.

The optional elevation-gear pawl assembly 4 and 6 provides a means for adjusting the elevating of the Javelin specific component set 10 with respect to the point where the pintle connector 2 is mounted on a base. In the preferred embodiment the elevation component consists of a geared-tooth plate 4 coupled to the pintle 2. A pawl assembly 6 is positioned at a point generally distal from the pintle 2. Releasing and engaging the geared-tooth plate 4 with the pawl assembly 6 allows for the pawl assembly 6 and the lower rigid structure 8 to be repositioned and fixed in that new position. By having the elevation component coupled between the pintle 2 and the lower rigid structure 8 the elevation-gear pawl assembly 4 and 6 provides an angle adjustment as a component of the elevation adjustment.

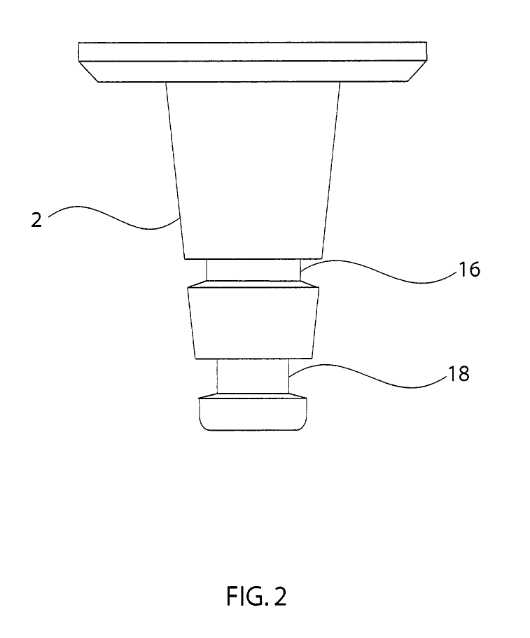

In FIG. 2 an enlarged view of the pintle connector 2 is shown in isolation. It is a common interface connector used by the military for mounting numerous weapon systems to various bases. The pintle 2 is tapered with grooves 16 and 18 cut circumferentially at two locations. The circumferential grooves 16 and 18 provide a locking mechanism to retain the tapered pintle 2 within a tapered receptacle (not shown) while allowing a 360 degree rotation. The pintle 2 may be coupled with the assembly 4 and 6 or the lower rigid structure 8 by a permanent or nonpermanent means for coupling two such objects.

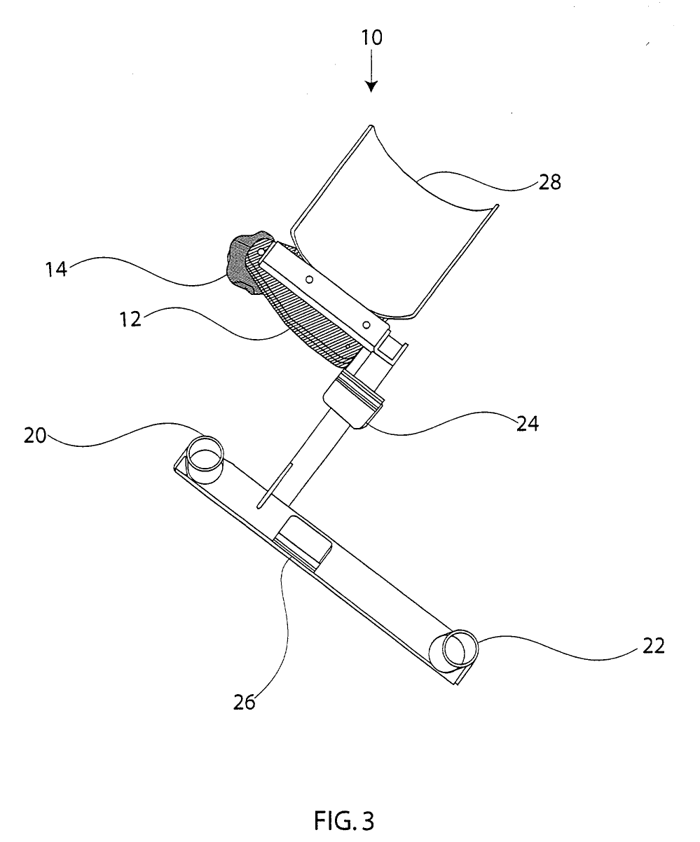

In FIG. 3 an enlarged overhead view of the Javelin specific component set 10 is shown. The Javelin component set 10 has two cup-shaped receptacles 20 and 22 and two L-shaped support brackets 24 and 26 positioned on and fixed to the component set structure for cradling the Command Launch Unit. A saddle-shaped feature 28 for cradling the Javelin Weapon System round is positioned on and fixed to the Javelin component set 10. A means for securing either configuration of the Javelin Weapon System to the Javelin specific component set 10 is provided but not shown. In the preferred embodiment the Javelin component set 10, the receptacles 20 and 22, the brackets 24 and 26, the saddle shaped feature 28, and the means for securing are designed to allow clear access to all controls and operator interfaces for operation of either configuration of the Javelin Weapon System.

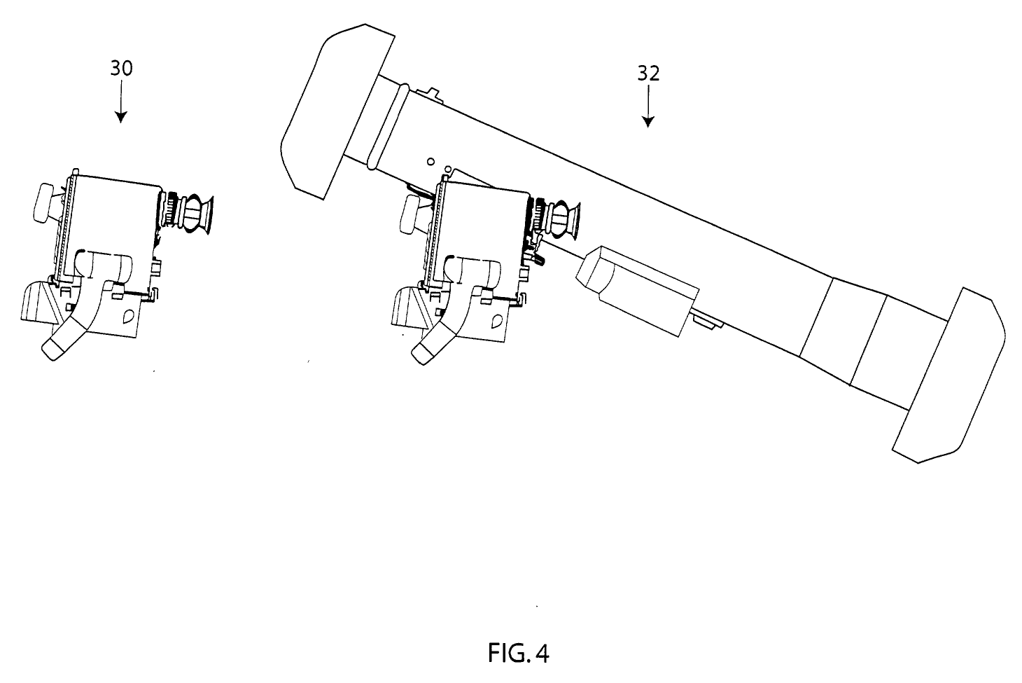

In FIG. 4 the two configurations of the Javelin Weapon System are shown: Command Launch Unit alone 30; and the Command Launch Unit mated with a round 32.

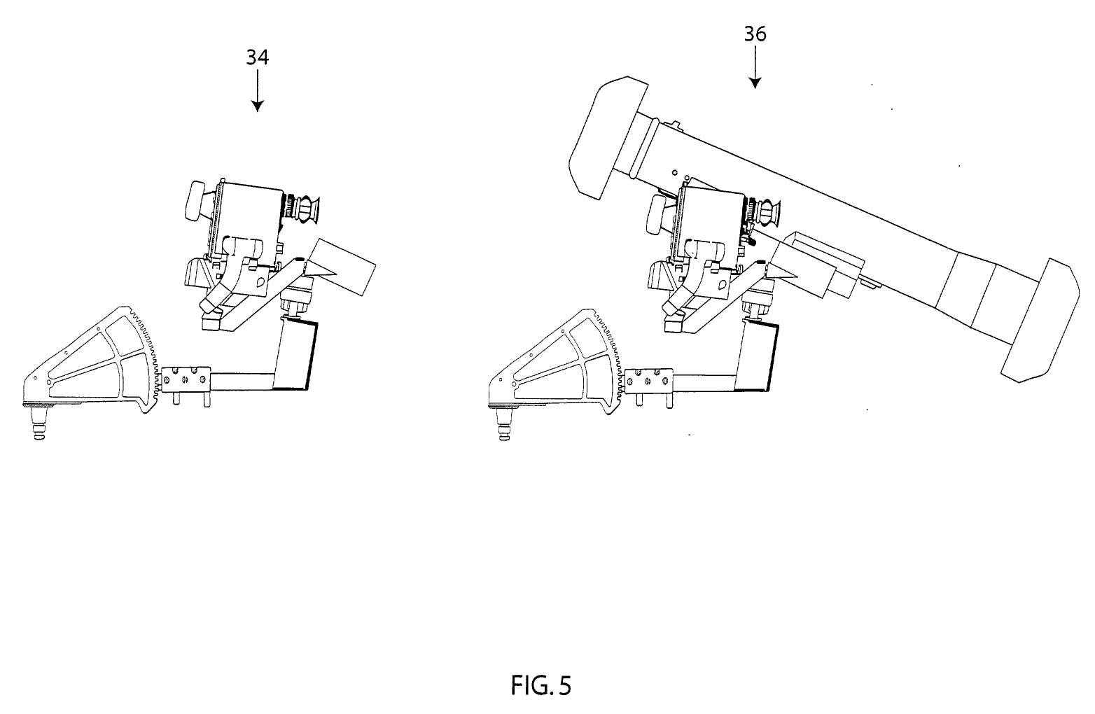

In FIG. 5 the perferred embodiment is shown with the two configurations of the Javelin weapon system 34 and 36 integrated.

While the above is the preferred embodiment, several of the components each represent a specific means for accomplishing a specified function. Any means known and used for any similar functions may be substituted as an equivalent for the above described means. As an example, the hydraulic component of U.S. Pat. No. 5,922,987, when used with a single valve controlling both “traverse and elevation” (i.e., tilt and pan), could be substituted for the ball joint assembly 12 and the control knob 14. Where one component is used to perform two functions (e.g., the elevation and angling component), two separate components may be substituted as equivalents. The preferred embodiment is implicitly mounted “upon” a base. However, the claims are not limited to any specific orientation. For example, the universal mounting system can be mounted underneath the “base” or on an incline.

Although a particular embodiment and form of the universal mounting system has been illustrated, it is apparent that various modifications and embodiments of the universal mounting system may be made by those skilled in the art without departing from the scope and spirit of the foregoing disclosure. Accordingly, the scope of the universal mounting system should be limited only by the claims appended hereto.

We claim:

1. A universal mounting system comprising:
an upper rigid structure,
a lower rigid structure,
a means for coupling the upper rigid structure with the lower rigid structure said means permitting a pan and tilt motion of the upper rigid structure with respect to the lower rigid structure,
a means for attaching a device to the upper rigid structure, and
a means for mounting the lower rigid structure to a base at a point generally distal to the means for coupling.

2. The universal mounting system as set forth in claim 1, wherein the means for panning and tilting the upper rigid structure is a ball joint.

3. The universal mounting system as set forth in claim 2, further comprising a means coupled with the ball joint for locking and unlocking the ball joint at any panning and tilting position.

4. The universal mounting system as set forth in claim 3, wherein the means for locking and unlocking the ball joint is a friction means for controlling and setting a desired friction upon the ball joint, with the friction varying from free movement to full lock.

5. The universal mounting system as set forth in claim 4, further comprising an elevation adjustment means positioned between the means for mounting and the lower rigid structure for fixing the lower rigid structure at a range of elevations with respect to the point where the system is mounted to the base.

6. The universal mounting system as set forth in claim 3, further comprising an elevation adjustment means positioned between the means for mounting and the lower rigid structure for fixing the lower rigid structure at a range of elevations with respect to the point where the system is mounted to the base.

7. The universal mounting system as set forth in claim 2, further comprising an elevation adjustment means positioned between the means for mounting and the lower rigid structure for fixing the lower rigid structure at a range of elevations with respect to the point where the system is mounted to the base.

8. The universal mounting system as set forth in claim 1, further comprising an elevation adjustment means positioned between the means for mounting and the lower rigid structure for fixing the lower rigid structure at a range of elevations with respect to the point where the system is mounted to the base.
